(19) United States
(12) Patent Application Publication
(10) Pub. No.: US 2019/0139429 A1
(43) Pub. Date: May 9, 2019

(54) A METHOD AND APPARATUS FOR PROVIDING EDUCATIONAL MATERIAL

(71) Applicant: StudyBee AB, MALMÖ (SE)

(72) Inventors: Ian RATTIGAN, Löberöd (SE); Ted MÖLLER, HELSINGBORG (SE); Mats CARLSSON, SVEDALA (SE); Daniel RONNSTAM, MALMÖ (SE)

(21) Appl. No.: 16/310,015

(22) PCT Filed: Jun. 14, 2017
(86) PCT No.: PCT/EP2017/064608

§ 371 Date: Dec. 14, 2018

(30) Foreign Application Priority Data
Jun. 14, 2016 (SE) 1650831-9

(51) Int. Cl. G09B 5/12; G06F 16/9535

(52) U.S. Cl. CPC G09B 5/12; G06F 16/9535

(57) ABSTRACT

The inventive concept relates to a method for providing digital educational material. The digital educational material is associated with an attribute set, the attribute set comprising a number of indirect attributes. The method comprises receiving input data related to at least one attribute of the attribute set; identifying a subset of the digital educational material, the subset comprising posts comprising the at least one attribute; sorting the posts based on the attribute set; and presenting the posts. The inventive concept further relates to a data processing apparatus for providing digital educational material.

### TECHNICAL FIELD

The inventive concept described herein generally relates to the field of technologies for handling educational material. More particularly, it is presented methods and apparatuses for providing educational material.

### BACKGROUND

In the field of education, it has heretofore been difficult for instructors to select the best teaching materials. With the development of open education programs, there has been an increase in the number of available educational materials. In addition, few instructors share educational material between each other, and the possibility to receive feedback on educational material is limited.

In order to ensure the quality of the educational material, it is common for an instructor to use educational material certified by a third party, such as a publisher, or to create the educational material him/herself.

Consequently, there is a need to improve the management of educational material.

### SUMMARY OF THE INVENTION

It is an object of the present inventive concept to mitigate, alleviate or eliminate one or more of the above-identified deficiencies in the art and disadvantages singly or in combination.

According to a first aspect of the inventive concept, these and other objects are achieved in full, or at least in part, by a method for providing digital educational material, the digital educational material being associated with an attribute set, the attribute set comprising a number of indirect attributes. The method comprises receiving input data related to at least one attribute of the attribute set; identifying a subset of the digital educational material, the subset comprising posts comprising the at least one attribute; sorting the posts based on the attribute set; and presenting the posts.

The number of indirect attributes may be related to a use of the digital educational material and/or to communication between users of the digital educational material.

The method may further comprise the step of suggesting assessment criteria and/or related educational material for at least one of said posts.

The digital educational material may comprise an assignment related to content of the digital educational material.

The digital educational material may comprise assessment criteria related to the assignment.

The method may further comprise receiving input data related to a selected post of the posts; identifying user data; and setting up a new assignment in a digital classroom environment based on the selected post and the user data.

The attribute set may comprise the indirect attributes and direct attributes, wherein the direct attributes are directly entered by users.

The indirect attributes may be selected from the group consisting of a grade improvement potential, an elapsed time studying the digital educational material, a subsequent digital educational material most often used, a subsequent assessment criteria most often used, a course most often used, a class most often used, and a grade associated with a user of the digital educational material.

According to a second aspect of the inventive concept, these and other objects are achieved in full, or at least in part, by a data processing apparatus for providing digital educational material, the digital educational material being associated with an attribute set, the attribute set comprising a number of indirect attributes, the data processing apparatus being configured to store the digital educational material; receive input data related to at least one attribute of the attribute set; identify a subset of the digital educational material, the subset comprising posts comprising the at least one attribute; sort the posts based on the attribute set; and present the posts.

According to a third aspect of the inventive concept, these and other objects are achieved in full, or at least in part, by a computer program comprising computer program code adapted to perform the method according to the first aspect of the inventive concept.

Other objectives, features and advantages of the present invention will appear from the following detailed disclosure, from the attached claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The above, as well as additional objects, features and advantages of the present invention/inventive concept, will be better understood through the following illustrative and non-limiting detailed description of different embodiments of the present invention/inventive concept, with reference to the appended drawings, wherein:

FIG. 1 schematically illustrates an educational material ecosystem.

FIG. 2 schematically illustrates a search result of educational material.

### DETAILED DESCRIPTION

This disclosure describes methods and apparatuses for providing educational material. Initially, some terminology may be defined to provide clarification for the following disclosure.

The term “assessment criteria” refer to, in the context of schools, the knowledge requirements defining what objectives is necessary for a student to demonstrate in order to receive different grades. Assessment criteria may be presented in general terms, such as “ability to include alternative ideas”, “critical awareness”. Assessment criteria may also be presented as an indication of the skills to be assessed in an assignment, such as “reading comprehension”, “spelling”, and so on.

The term “computer” may refer to any data processing device. As will be readily understood by a person skilled in the art, a computer may refer to a plurality of data processing devices.

The term “course” may be interchangeably used with the term “subject”.

The term “use” may refer to, in the context of using educational material, the use of educational material for the purpose of education. However, it is therefore not said that the content of the educational material was necessarily created for educational purposes.

The term “grade” may refer to an assessment given to an assessee, such as a numerical grade, e.g. 1, 2, and 3, an alphabetical grade, e.g. A, B, and C, or any other type of grade.

For the reader's convenience, a school year is not referred to by the commonly used term “grade”, but in contrast by the term “class”. For example, a first year student may be referred to as a student in first class.

Throughout the disclosure, examples are described in the context of a teacher-student environment. However, this does not imply that the methods and apparatuses disclosed are limited to the typical teacher-student environments such as schools or the like. In contrast, the methods and apparatuses may be used in any context where educational material is used, for example in sports teams. Further, an instructor, for example a teacher, does not necessarily have to be a person, but may in contrast be represented by artificial intelligence (AI). Thus, an assessment may be made by artificial intelligence.

Further, throughout the disclosure, reference is made to “educational material”. The educational material may be a digital educational material.

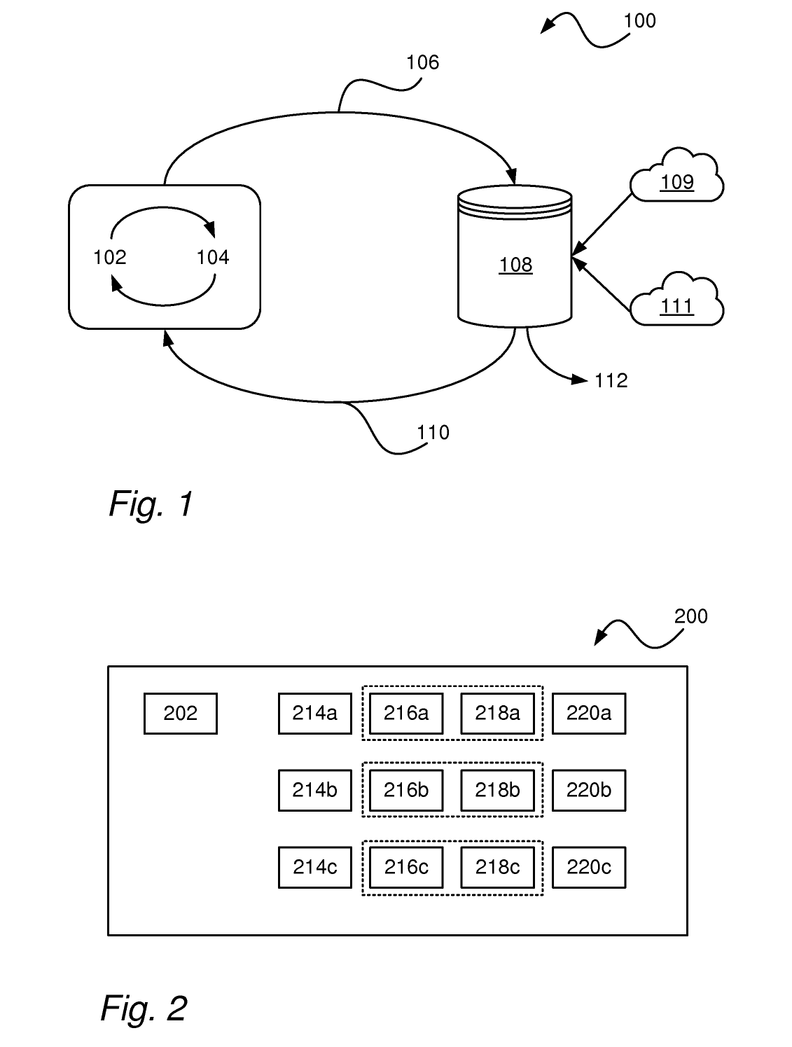

FIG. 1 generally illustrates an educational material ecosystem 100. In other words, it is illustrated how data formed when using educational material can be used for improving the educational material. Over time, the educational material ecosystem may provide educational material which has been subject to indirect evaluation from a number of users through a number of updates of indirect attributes associated with the educational material. A database 108 may contain educational material. The educational material may origin from any content available on the Internet 109. Educational material may be provided to the database 108 and/or created by an instructor by connecting an assignment and/or assessment criteria to any content and entering the content to the database 108. Educational material may be provided to the database 108 by a professional provider 111 of educational material. The database 108 may be divided in several databases. The educational material is associated with attribute sets comprising indirect attributes, which is further discussed below.

The following is an example of how the educational material ecosystem may improve educational material over time. An instructor 102 may acquire educational material 110 from the database 108 to be used in a digital educational platform, such as Google Classroom. The instructor may have created his or her own educational material by connecting an assignment to any content available to the instructor. Alternatively, the instructor may use educational material already provided in the database 108. The educational material may comprise assessment criteria. At any time, the instructor may directly add data to the attribute set associated with the educational material. For example, the instructor may add data indicating that the educational material is suitable for a specific course. The data relating to the specific course is thus comprised in the attribute set associated with the educational material. More particularly, the data relating to the specific course is a direct attribute associated with the educational material. In other words, data directly entered by a user indexing and/or assessing the educational material may be considered to be comprised in a direct attribute. Further, system created data may be considered to be comprised in a direct attribute. For example, a date of creation of educational material and/or date of latest use of educational material may be considered to be comprised in a direct attribute. The direct attributes may comprise data relating to an author of the educational material, and/or a date of creation of the educational material, and/or a date of use of the educational material, and/or a suitable grade as determined by an instructor, and/or a suitable course as determined by an instructor, and/or a rating of the educational material based on ratings from any user of the educational mater, and/or a recommendation of the educational material from a user, and/or comments made in connection to the educational material from a user. The instructor may then assign the educational material to a specific course 104 and/or a number of individuals 104 through a digital educational platform. The digital educational platform may communicate with the database 108. The specific course 104 being assigned the educational material may be associated with a class, such as 3^{rd} class, 4^{th} class, 5^{th} class, and so on. Thus, the attribute set associated with the assigned educational material may be updated with data related to the class for which the educational material has been used. More particularly, the data relating to which class the educational material has been used for is an indirect attribute associated with the educational material. In other words, the instructor has not necessarily made a conscious decision that the educational material is suitable for that particular class. In contrast, the indirect attributes of the educational material may be updated based on how the educational material is used. Further, the indirect attributes of the educational material may be updated based on observations of how the educational material is used. Similarly, the instructor may assign the educational material to a different course. In that case, an indirect attribute associated with the educational material may be updated with data related to the course for which the educational material has been used. For example, the instructor may initially have deemed the educational material to be suitable for a course in history and added such data to the educational material in question. However, the instructor may also assign the same educational material to a course in grammar. Thus, indirect attributes associated with the educational material is updated with data reflecting that the educational material has been used in a grammar course. The attribute set associated with the educational material may be updated based on data acquired 106 during the assignment. The data acquired 106 may comprise information relating to student grades, and/or time elapsed until completion of the assignment, and/or amendments made by the instructor. The data acquired 106 may be related to communication between a student 104 and an instructor 102. In the example described above reference is made to a single instructor. However, it is to be understood that multiple instructors may use the same educational material, and that the attribute set associated with the educational material may be updated similarly according to each instructor's use of the educational material.

In general, the above described example may be referred to as a form of quality assurance of educational material from a number of users. More particularly, each user using the educational material may indirectly update the indirect attributes associated with the educational material, providing information for other users who wish to use the same educational material.

Below follows a few examples of indirect attributes which may be included in the attribute set associated with the educational material.

The indirect attributes may comprise data relating to a grade improvement potential. An individual receiving educational material in a specific course may be associated with a grade. After receiving and using the educational material, the student may be assessed by a teacher. The assessment may be based on an assignment related to the content of the educational material, but the assessment may also be separate from the received educational material. The student may receive a new grade through the assessment, and an indirect attribute associated with the received educational material comprising data relating to a grade improvement potential may thus be updated. Through a plurality of assessments based on the educational material, and subsequently a plurality of updates of data relating to a grade improvement potential, it may be possible to deduct that a student receiving the educational material is likely to improve his or her grade.

The indirect attributes may comprise data relating to an elapsed time. The elapsed time may be the amount of time spent by an individual studying an educational material. The elapsed time may be the amount of time spent by an individual studying part of an educational material. For example, the indirect attributes may reflect the time spent by an individual reading a first page of an educational material, as well as the time spent by an individual reading all pages of an educational material. For example, time spent may be logged if the educational material is read on a tablet or other electronic device. An indirect attribute associated with the received educational material comprising data relating to an elapsed time may thus be updated. By analyzing time elapsed studying educational material, and correlating the elapsed time with the grades of individuals who studied the educational material, it may be possible to determine if the educational material provides an adequate challenge for an individual with a specific grade. Further, it may provide information to a teacher as to how long it takes on average for a student to study said educational material, which facilitates time management and planning for the teacher.

The indirect attributes may comprise data relating to a next step. A timeline comprising educational material may be generated by analyzing data of attribute sets associated with the educational material. For example, in a course perspective, educational material associated with an attribute set comprising a specific course may be sorted based on their relative assignment in time to the specific course. Thus, an educational material A assigned to a specific course or individual prior to the assignment of an educational material B, may have an indirect attribute relating to a next step updated with data reflecting that educational material B has been used as further reading. Over time, the educational material most often used subsequent to the assignment of educational material A may be reflected in data comprised in the indirect attributes of educational material A. Similarly, in another perspective, it may be possible to sort educational material based on a specific assessment criteria. Thus, an educational material C connected to a first specific assessment criteria, assigned to a course or individual prior to the assignment of an educational material D connected to a second specific assessment criteria, may have an indirect attribute relating to a next step updated with data reflecting that the second specific assessment criteria has been used as a next step. Over time, the assessment criteria most often used subsequent to the assignment of educational material C may be reflected in data comprised in the indirect attributes of educational material C. The first and second specific assessment criteria may be different assessment criteria, or the same assessment criteria.

The indirect attributes may comprise data relating to a specific grade associated with the individual to which the educational material was assigned.

The indirect attributes may comprise data relating to previous users of the educational material.

The indirect attributes may comprise data relating to an analysis of communication between an instructor and a student in connection to educational material. For example, if a specific subject is mentioned in communication between the instructor and student in connection to a specific educational material, an analysis may determine that the specific educational material is suitable for the specific subject. Thus, the indirect attribute relating to subject may be updated with data reflecting that the specific educational material is suitable for the specific subject.

Now referring to FIG. 2, an example of how a search result 200 may be presented on a screen is illustrated. A search may be performed on the basis of a number of direct and/or indirect attributes 202 of the attribute set associated with educational material comprised in the database. The search may be performed on the basis of a number of keywords. The number of keywords may be set by a user. The search may result in a number of posts of educational material. The search result may present content 214a, 214b, 214c of a post. The content may be a link to a website, and/or a digital book, and/or a sound track, and/or a video, and/or an image. The search result may present direct attributes 216a, 216b, 216c, and/or indirect attributes 218a, 218b, 218c, of a post. The search result may present assessment criteria 220a, 220b, 220c, of a post. The assessment criteria may be comprised in the direct or indirect attributes. The search result may present information about the type of provider which provided the educational material of a specific post. The type of provider may be the Internet, a professional provider of educational material, or an instructor.

In general terms, the inventive concept disclosed above may be described as a method for providing digital educational material, wherein the digital educational material is associated with an attribute set. The attribute set comprises a number of indirect attributes. The method further comprises receiving input data 202 related to at least one attribute of the attribute set, and identifying a subset of the digital educational material. The subset may comprise a number of posts comprising the at least one attribute. The posts may be sorted based on direct attributes 216a, 216b, 216c, and/or indirect attributes 218a, 218b, 218c.

A user may select a post in the search result for assigning the educational material connected to the post to a digital educational platform.

The data comprised in the attribute sets associated with educational material may be of interest to third parties for analyzing trends and behavior in educational environments. Thus, with reference to FIG. 1, the educational material comprised in the database may be analyzed 112 based on any combination of attributes comprised in the attribute sets associated with the educational material.

In other words, the direct attributes can be attributes directly assigned by the instructor and/or by the users, while the indirect attributes can be set automatically based on how the educational material actually is used. By having the indirect attributes, an improved search function can be achieved, as illustrated in FIG. 2 by way of example, since it is made possible to not only share the educational material itself, but also how it has been used by others. In addition, having the indirect attributes determined automatically provides for a cost efficient and consistent assessment of the educational material.

The inventive concept has mainly been described above with reference to a few embodiments. However, as is readily appreciated by a person skilled in the art, other embodiments than the ones disclosed above are equally possible within the scope of the invention, as defined by the appended patent claims.

### LIST OF REFERENCE SIGNS

100 Digital material ecosystem

102 Instructor

104 Student

106 Acquired data

108 Database

109 Internet

110 Educational material

111 Professional provider

112 Analysis

200 Search result

202 Input data

214a Content

214b

214c

216a Direct attributes

216b

216c

218a Indirect attributes

218b

218c

220a Assessment criteria

220b

220c

1. A method for providing digital educational material, said digital educational material being associated with an attribute set, said attribute set comprising a number of indirect attributes, wherein said method comprises:
receiving input data related to at least one attribute of said attribute set;
identifying a subset of said digital educational material, said subset comprising posts comprising said at least one attribute;
sorting said posts based on said attribute set; and
presenting said posts.

2. The method according to claim 1, wherein said number of indirect attributes is related to a use of said digital educational material and/or to communication between users of said digital educational material.

3. The method according to claim 1, further comprising the step of suggesting assessment criteria and/or related educational material for at least one of said posts.

4. The method according to claim 1, wherein said digital educational material comprises an assignment related to content of said digital educational material.

5. The method according to claim 4, wherein said digital educational material comprises assessment criteria related to said assignment.

6. The method according to claim 1, further comprising
receiving input data related to a selected post of said posts;
identifying user data; and
setting up a new assignment in a digital classroom environment based on said selected post and said user data.

7. The method according to claim 1, wherein said attribute set comprises said indirect attributes and direct attributes, wherein said direct attributes are directly entered by users.

8. The method according to claim 1, wherein said indirect attributes are selected from the group consisting of a grade improvement potential, an elapsed time studying said digital educational material, a subsequent digital educational material most often used, a subsequent assessment criteria most often used, a course most often used, a class most often used, and a grade associated with a user of said digital educational material.

9. A data processing apparatus for providing digital educational material, said digital educational material being associated with an attribute set, said attribute set comprising a number of indirect attributes, said data processing apparatus being configured to
store said digital educational material;
receive input data related to at least one attribute of said attribute set;
identify a subset of said digital educational material, said subset comprising posts comprising said at least one attribute;
sort said posts based on said attribute set; and
present said posts.

10. A computer program comprising computer program code adapted to perform the method of claim 1, when said computer program is run on a computer.
